(19) United States
(12) Patent Application Publication
(10) Pub. No.: US 2025/0309783 A1
(43) Pub. Date: Oct. 2, 2025

(54) FRONT-END ACTIVE RECTIFIER USING SINGLE INDUCTOR AND SERIES STACKED HALF BRIDGES FOR ISOLATED POWER SUPPLIES

(71) Applicant: Apple Inc., Cupertino, CA (US)

(72) Inventor: Noureldeen M. Elsayad, Santa Clara, CA (US)

(21) Appl. No.: 18/624,695

(22) Filed: Apr. 2, 2024

(51) Int. Cl. H02M 7/25; H02M 1/00; H02M 3/00; H02M 3/335

(52) U.S. Cl. CPC H02M 7/25; H02M 1/0043; H02M 1/0067; H02M 3/015; H02M 3/33571; H02M 3/33576

(57) ABSTRACT

A power supply can include a rectifier that receives an AC input voltage and produces a rectified output voltage; a plurality of series-stacked half bridges (SSHBs), each including upper and lower switches; and a plurality of isolated DC-DC converters each having an input coupled to a respective high side node and low side node of a corresponding SSHB and all having their outputs connected in parallel to provide a DC output voltage for the power supply. The plurality of SSHBs can further include a first SSHB having a switch node coupled to the rectifier by a single inductor and operable to produce a first floating DC bus across high side and low side nodes; and one or more additional SSHBs each having a switch node coupled to a low side node of a preceding SSHB and operable to produce a floating DC bus across high side and low side nodes.

### BACKGROUND

Isolated Power Supply Units (“PSUs”) may be used in a variety of modern day consumer electronics. Such PSUs convert an AC input voltage (e.g., from a power plug) to a (typically lower) DC voltage (e.g., 12V) suitable for the electronic devices. One popular topology, due to its low cost and simple structure, is a conventional 2-level boost converter followed by an LLC converter. For some applications, Multilevel Flying Capacitor (MFC) and Input-Series-Output-Parallel (ISOP) converters have been investigated and proposed as alternative topologies. In at least some embodiments, such topologies can have advantages such as the reduction in the passive sizes component (e.g., for power factor correction chokes, boost capacitors, EMI filter inductors and capacitors, etc.), and reduced cooling system requirement. However, such topologies can also have drawbacks such as increased numbers of passive components (e.g., inductors and capacitors) which can increase cost of the PSU and reduce its reliability. Additionally, such topologies may require complex extra circuitry to actively balance the voltage sharing on the converter components and stages.

### SUMMARY

Disclosed herein are various embodiments of a front-end active rectifier using single inductor and series stacked half bridges for isolated power supplies topology that, in at least some embodiments, can incorporate various advantages of the MFC and ISOP converters described above while reducing the need for extra passive components. Additionally, voltage balancing on its stages can be achieved without the need for extensive additional control circuitry. In at least some embodiments, such converters can easily adopt conventional controls used in the 2-level boost converter. The applications of the proposed converter can be extended to include on-board chargers and solar power systems as well as numerous other applications.

An AC/DC power supply can include a rectifier that receives an AC input voltage and produces a rectified output voltage; a plurality of series-stacked half bridges, each of the plurality of series-stacked half bridges including an upper switching device and a lower switching device; and a plurality of isolated DC-DC converters each having an input coupled to a respective high side node and low side node of a corresponding series-stacked half bridge and all having their outputs connected in parallel to provide a DC output voltage for the AC/DC power supply. The plurality of series-stacked half bridges can further include a first series-stacked half bridge having a switch node coupled to the rectifier by a single inductor and operable to produce a first floating DC bus across high side and low side nodes; and one or more additional series-stacked half bridges each having a switch node coupled to a low side node of a preceding series-stacked half bridge and operable to produce a floating DC bus across high side and low side nodes.

The upper switching device can be a diode, and the lower switching device can be a transistor. The AC/DC power supply can further include a plurality of bulk capacitors coupled across the high side and low side nodes of respective series-stacked half bridges. The AC/DC power supply can further include control circuitry for the plurality of isolated DC-DC converters that ensures equal power sharing between the plurality of isolated DC-DC converters. The control circuitry that ensures equal power sharing between the plurality of isolated DC-DC converters can compare a target floating DC bus voltage to a voltage of each floating DC bus and generate therefrom a small variation of a manipulated variable of a controller of a corresponding DC-DC converter. The manipulated variable can be switching frequency of the corresponding DC-DC converter. The manipulated variable can be a resonant capacitor voltage of the corresponding DC-DC converter.

The AC/DC power supply can further include control circuitry for the plurality of series-stacked half bridges that compares the rectified output voltage to a sum of voltages on the isolated DC busses and generates therefrom a reference current signal for a current controller of each series-stacked half bridge. The current controller can be selected from the group consisting of a peak current controller and an average current controller and can operate in a mode selected from a continuous conduction mode, a discontinuous conduction mode, and a critical conduction mode. The control circuitry for each series-stacked half bridge can generate phase shifted drive signals for at least the low side switch of each series-stacked half bridge by comparing the reference current signal to a plurality of phase shifted carrier signals, wherein the carrier signals are phase shifted with respect to each other by 360/n degrees, where n is a number of series-stacked half bridges in the plurality. The number of series-stacked half bridges can be two or 3. The isolated DC-DC converters can be LLC converters or CLLC converters.

A unidirectional AC/DC power supply can include a rectifier that receives an AC input voltage and produces a rectified output voltage; a plurality of series-stacked half bridges, wherein each of the plurality of series-stacked half bridges includes an upper switching device and a lower switching device; a plurality of bulk capacitors coupled across the high side and low side nodes of respective series-stacked half bridges; and a plurality of LLC converters each having an input coupled to a respective high side node and low side node of a corresponding series-stacked half bridge and all having their outputs connected in parallel to provide a DC output voltage for the AC/DC power supply. The plurality of series-stacked half bridges can further include a first series-stacked half bridge having a switch node coupled to the rectifier by a single inductor and operable to produce a first floating DC bus across high side and low side nodes; and one or more additional series-stacked half bridges each having a switch node coupled to a low side node of a preceding series-stacked half bridge and operable to produce a floating DC bus across high side and low side nodes.

The unidirectional AC/DC power supply can further include control circuitry for the plurality of LLC converters that ensures equal power sharing between the plurality of LLC converters. The unidirectional AC/DC power supply can further include control circuitry for the plurality of series-stacked half bridges that compares the rectified output voltage to a sum of voltages on the isolated DC busses and generates therefrom a reference current signal for a current controller of each series-stacked half bridge.

A bidirectional AC/DC power supply can include a rectifier that receives an AC input voltage and produces a rectified output voltage; a plurality of series-stacked half bridges, wherein each of the plurality of series-stacked half bridges includes an upper switching device and a lower switching device; a plurality of bulk capacitors coupled across the high side and low side nodes of respective series-stacked half bridges; and a plurality of CLLC converters each having an input coupled to a respective high side node and low side node of a corresponding series-stacked half bridge and all having their outputs connected in parallel to provide a DC output voltage for the bidirectional AC/DC power supply. The plurality of series-stacked half bridges can include a first series-stacked half bridge having a switch node coupled to the rectifier by a single inductor and operable to produce a first floating DC bus across high side and low side nodes; and one or more additional series-stacked half bridges each having a switch node coupled to a low side node of a preceding series-stacked half bridge and operable to produce a floating DC bus across high side and low side nodes.

The bidirectional AC/DC power supply can further include control circuitry for the plurality of CLLC converters that ensures equal power sharing between the plurality of CLLC converters. The bidirectional AC/DC power supply can further include control circuitry for the plurality of series-stacked half bridges that compares the rectified output voltage to a sum of voltages on the isolated DC busses and generates therefrom a reference current signal for a current controller of each series-stacked half bridge.

### BRIEF DESCRIPTION OF THE DRAWINGS

FIG. 1 illustrates an isolated AC-DC power supply incorporating a front-end active rectifier using single inductor and series stacked half bridges.

FIG. 2 illustrates an equivalent circuit of the isolated AC-DC power supply incorporating a front-end active rectifier using single inductor and series stacked half bridges of FIG. 1 with the isolated DC-DC converters depicted as resistive loads.

FIG. 3 illustrates a power sharing control loop for an isolated AC-DC power supply incorporating a front-end active rectifier using single inductor and series stacked half bridges as described above.

FIG. 4 illustrates an outer voltage control loop for an isolated AC-DC power supply incorporating a front-end active rectifier using single inductor and series stacked half bridges as described above.

FIG. 5 illustrates a switching sequence for the series-stacked half bridges of a converter as described above for duty cycles greater than 50%.

FIG. 6 illustrates a switching sequence for the series-stacked half bridges of a converter as described above for duty cycles less than 50%.

FIG. 7 illustrates conduction paths during the respective switching states of the series-stacked half bridges.

FIG. 8 illustrates a unidirectional converter including an isolated AC-DC power supply incorporating a front-end active rectifier using single inductor and series stacked half bridges.

FIG. 9 illustrates a bidirectional converter including an isolated AC-DC power supply incorporating a front-end active rectifier using single inductor and series stacked half bridges.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

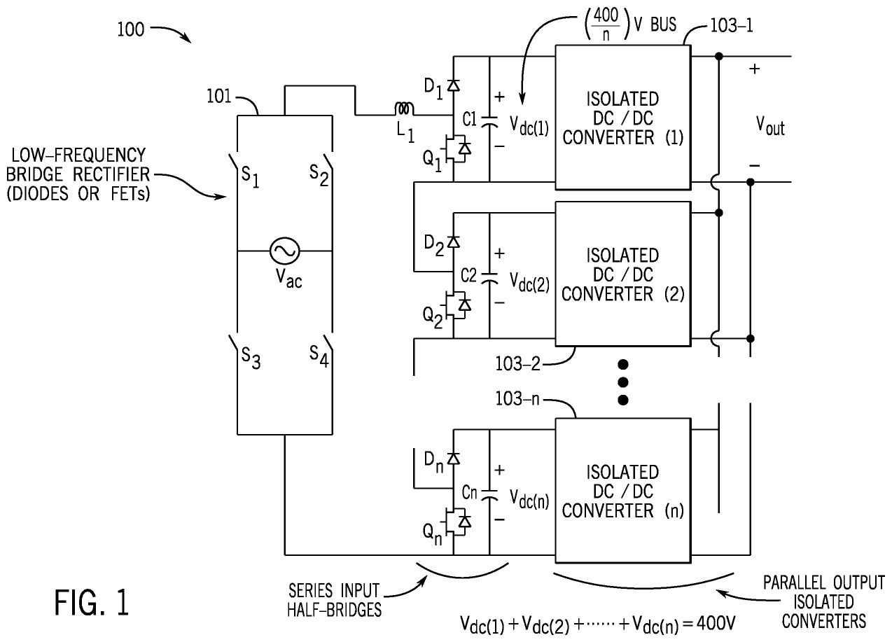

FIG. 1 illustrates an isolated AC-DC PSU 100 incorporating a front-end active rectifier using single inductor and series stacked half bridges. The proposed isolated PSU 100 can include a rectifier 101 that receives an input AC voltage Vac. The rectifier can be a full bridge (as shown), half bridge, or other rectifier made up of switching devices, e.g., switching devices S1-S4 in the illustrated full bridge configuration. The switching devices can be diodes, transistors, or other suitable semiconductor switching devices. The input voltage may be any of a variety of values such as 100Vac, 110Vac, 115Vac, 120Vac, 230Vac, 240Vac, etc. Such voltages may, but need not correspond to AC voltages available in wall plugs in various parts of the world. The rectified AC voltage can produce a rectified bus voltage, which for purposes of the following description will be described as 400V, to correspond to a highest value that may be expected based on various worldwide line voltages. However, any suitable bus voltage other than 400V may be used in a particular application or implementation.

PSU 100 can further include a single inductor (e.g., PFC Choke “L”) connected to a plurality series-stacked switching half bridges (D1/Q1, D2/Q2, . . . . Dn/Qn). Each switching half bridge is depicted as including an upper switching device (depicted as diodes D1-Dn) and a lower switching device Q1-Qn (depicted as MOSFETs). However, alternative switching devices could be used for both switches. That is, the upper switches D1-Dn could be replaced with active devices such as transistors, etc. Similarly, transistor types other than MOSFETs could be used for both the upper and lower switching devices. For each half bridge, the junction/common terminal of the upper and lower switching device is referred to herein as a first node or switch node. The other terminal of the upper switching device (e.g., the cathode of D1) is referred to herein as a second node, high node, or high side node. The other terminal of the lower switching device (e.g., the drain of switch Q1) is referred to herein as a third node, low node, or now side node.

Additionally, each half bridge can be series-stacked with the next, for example, such that a current flowing out of a low side node of the first half bridge D1/Q1 (i.e., through lower switch Q1) is then coupled to the switch node of the second half bridge D2/Q2 (i.e., the junction of upper switch D2 and lower switch Q2). Each of the series-stacked half bridges can be similarly coupled to the preceding and following half bridges in the series-stack. Such a configuration results in multiple floating DC buses Vdc(1), Vdc(2), . . . , Vdc(n) across the high/low nodes of each half bridge. Each floating DC bus can have a value that is the rectified AC voltage divided by the number of stages in the converter. Thus, for the 400V example discussed above, each floating bus Vdc(1), Vdc(2), . . . , Vdc(n) can have a voltage of

$$\frac{400}{n} V ,$$

where n is number of stages of the converter.

Each of the floating dc busses Vdc(1), Vdc(2), . . . , Vdc(n), can have a corresponding bulk capacitor C1, C2, . . . , Cn, such that the respective floating DC bus voltage appears across the corresponding capacitor. These floating bus voltages can be each be supplied as inputs to a respective isolated DC-DC converter 103-1, 103-2, 103-n. The isolated DC-DC converters can have various topologies, such as LLC converters, CLLC converters, etc. The outputs of the isolated DC-DC converters can be connected in parallel to provide an output voltage Vout with a current capability corresponding to the total current capability of the isolated DC-DC converters.

As described in greater detail below, the half-bridges can be driven by phase-shifted PWM signals, with each half-bridge being 360/n degrees out of phase with respect to the other. Thus, for a two-stage converter, the half-bridges can be 180 degrees out of phase; for a three-stage converter, the half-bridges can be 120 degrees out of phase, etc. This out-of-phase driving of the half bridges can have the effect of multiplying the frequency of the input ripple current, e.g., the input current though PFC choke L. As a result of this increased frequency, the size of PFC choke L can be reduced. Similarly, the size of other components, such as any EMI input filter (not shown) can also be reduced. Additionally, because of the input series stacking, the half bridges (D1/Q1, D2/Q2, . . . , Dn/Cn) and the isolated DC-DC converters (103-1, 103-2, . . . , 103-n) can use switching devices and capacitors with lower maximum voltage ratings. In other words, each of these components will only experience a voltage stress corresponding to 1/n times the rectified input voltage (e.g., 400V/n), where n is the number of converted stages. Additionally, the cooling requirements of the proposed converter may also be reduced by virtue of using multiple MOSFETs. For example, R_{th-junction-to-case} for multiple lower voltage MOSFETs can be less than that of a single high voltage MOSFET.

As a further comparison and illustration of advantages, if a conventional two-level boost converter PSU operates at switching frequency (F_{sw}) and has a ripple current (ΔI_{L}), its PFC choke inductance (L_{2L-boost}) can be compared to an n-stage series-connected half-bridges converter operating at the same switching frequency (F_{sw}) and having the same ripple current (ΔI_{L}) can be compared to the PFC choke inductance (L) as follows:

$$L = \frac{{L}_{2 L - boost}}{{( n )}^{2}}$$

In other words, an n-stage PSU constructed as described with reference to FIG. 1 can have an input inductance reduced by 1/n² as compared a conventional two-level boost converter PSU. Additionally, if the proposed converter has three stages, the voltage of each floating DC bus in a 400V system can be

$$\frac{400}{3} V = 133.3 V ,$$

which can allow for 200V MOSFETs can be used for both the half bridges and the primary side of the isolated dc/dc converters.

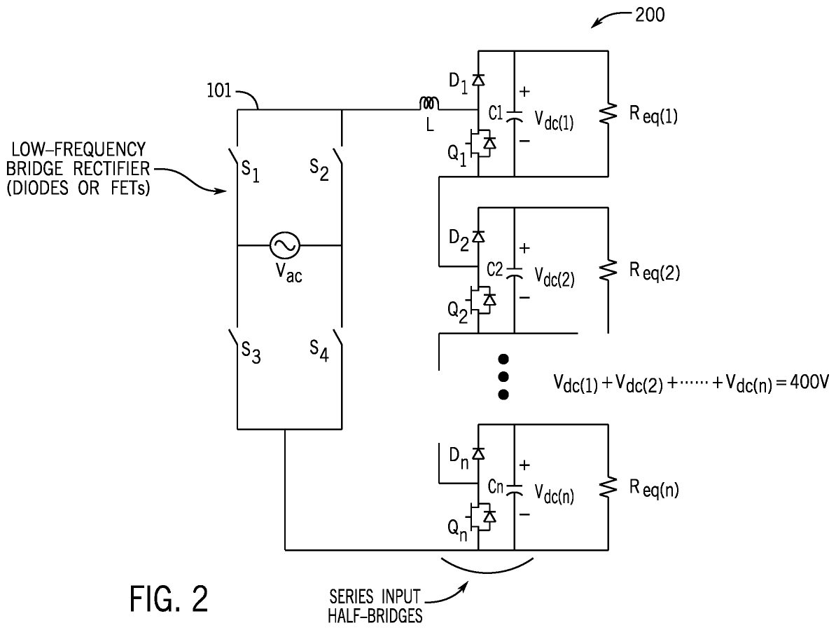

FIG. 2 illustrates an equivalent circuit of the isolated AC-DC power supply 200 incorporating a front-end active rectifier using single inductor and series stacked half bridges of FIG. 1 with the isolated DC-DC converters 103-1, 103-2, . . . , 103-n (FIG. 1) depicted as resistive loads (Req(1), Req(2), . . . , Req(n)). All the half bridges D1/Q1, D2/Q2, . . . , Dn/Qn can operate with the same switching duty cycle. If the isolated DC-DC converters are not equally sharing the load, unequal DC bus voltages Vdc(1), Vdc(2), . . . , Vdc(n) can result. If the isolated DC-DC converters are sharing the load equally, R_{eq} can be calculated as following:

$${R}_{e q} = \frac{{( 400 / n )}^{2}}{{P}_{out}}$$

(for the exemplary 400V total bus voltage example discussed herein). The voltage across each dc bus (in the case of equal power sharing by the isolated DC-DC converters) can be calculated as follows:

$${V}_{D C} ( i ) = \frac{400}{n} V$$

where i is the number of the stage. This voltage value for equal power sharing, which is the rectified input voltage divided by the number of stages, can be a target floating DC bus voltage. In case of unequal power sharing, the DC bus voltage will shift from the ideal value. The error

$$( {V}_{D C} ( i ) = \frac{400}{n} )$$

is inversely proportional with deviation in power sharing by each isolated DC-DC converter from the ideal value. If this error is positive, this means the isolated DC-DC converter is providing less power than the ideal (equal) value, and when the error is negative, this means the isolated DC-DC converter is providing more power than the ideal value. In this context ideal value means the equal power sharing as defined by

$$\frac{Total Output Load}{n} .$$

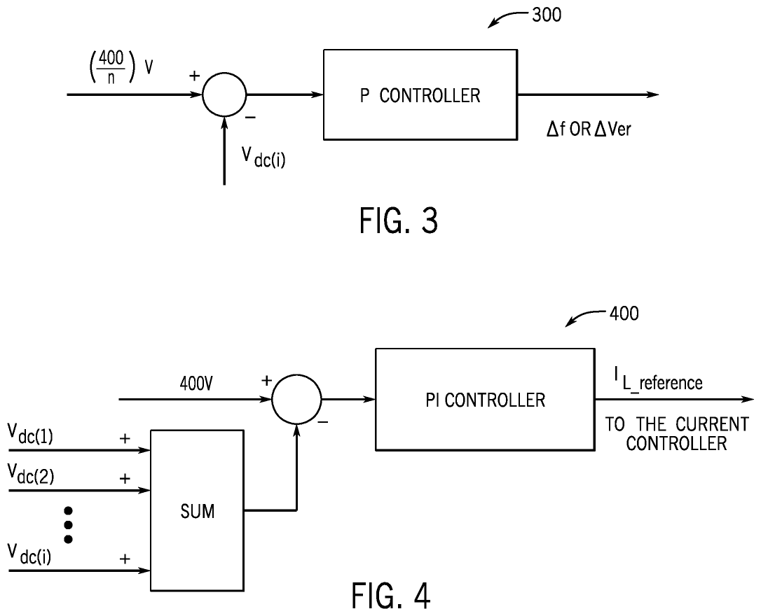

To ensure equal power sharing by each stage of the proposed converter, a power controller can be used. An exemplary power controller 300 is illustrated in FIG. 3, which illustrates a power sharing control loop for an isolated AC-DC power supply incorporating a front-end active rectifier using single inductor and series stacked half bridges as described above. Power controller 300 can take where it takes the error signal (e.g., a difference between the bus voltage of a stage (Vdc(i)) and the ideal bus voltage of each stage

$$( \frac{400}{n} )$$

and can generate theretrom a small variation of the manipulated variable of the outer loop controller of the isolated DC-DC converter of that stage. In some embodiments this can be performed by a proportional controller (i.e., P controller). In other embodiments, other controller types such as proportional-integral (PI), proportional-integral-derivative (PID), hysteretic controllers, etc. could also be used. Such control circuitry can be implemented using any suitable combination of analog, digital, programmable, and/or hybrid circuitries.

As an illustrative example, consider an isolated DC-DC converter that is an LLC converter controlled by a single loop that takes the error in output voltage and generates the operating switching frequency f of the converter (as a manipulated variable of the controller). In this case, the additional controller can reduce switching frequency f by a small portion Δf to increase the power processed by stage (i) by decreasing V_{dc(i)}. Alternatively, the additional controller can increase switching f by a small portion Δf to decrease the power processed by stage i by increasing V_{dc(i)}. In other embodiments, if the LLC converter is controlled by a charge controller, the outer loop can vary the resonant capacitor voltage V_{cr} (as a manipulated variable) to control the power processed by the converter. In this case, the additional controller can increase resonant capacitor voltage V_{cr} by a small portion Δ V_{cr} to increase the power processed by stage i by decreasing V_{dc(i)}. Conversely, the controller can reduce V_{cr} by Δ V_{cr} to decrease the power processed by stage i by increasing V_{dc(i)}. In any case, the output of each controller 300 can be provided to respective DC-DC converter stages to maintain equal power sharing as between the DC-DC converter stages.

FIG. 4 illustrates an outer voltage control loop 400 for an isolated AC-DC power supply incorporating a front-end active rectifier using single inductor and series stacked half bridges as described above. The series-connected half-bridges D1/Q1, D2/Q2, . . . , Dn/Qn, can be connected like a conventional two-level boost converter. One difference from the two-level boost converter case is that the reference voltage (e.g., 400V) can be compared to the sum of the floating dc bus voltages (Vdc(1), Vdc(2), . . . , Vdc(n)). The resulting error signal can be passed to a proportional-integral controller to generate the reference current of the input inductor (i.e., PFC choke L), as illustrated in FIG. 4. The controller could also be a proportional (P) controller, proportional-integral-derivative (PID) controller, hysteretic controller, etc. The reference current signal can be passed to any suitable current controller, such as a peak current controller or average current controller operating in a continuous conduction mode (CCM), discontinuous conduction mode (DCM), critical conduction mode (CrCM), etc. The current controller can thus produce a duty cycle value that can be used in all the series-connected half-bridges (with appropriate phase shifts as described in greater detail herein). Such control circuitry can be implemented using any suitable combination of analog, digital, programmable, and/or hybrid circuitries.

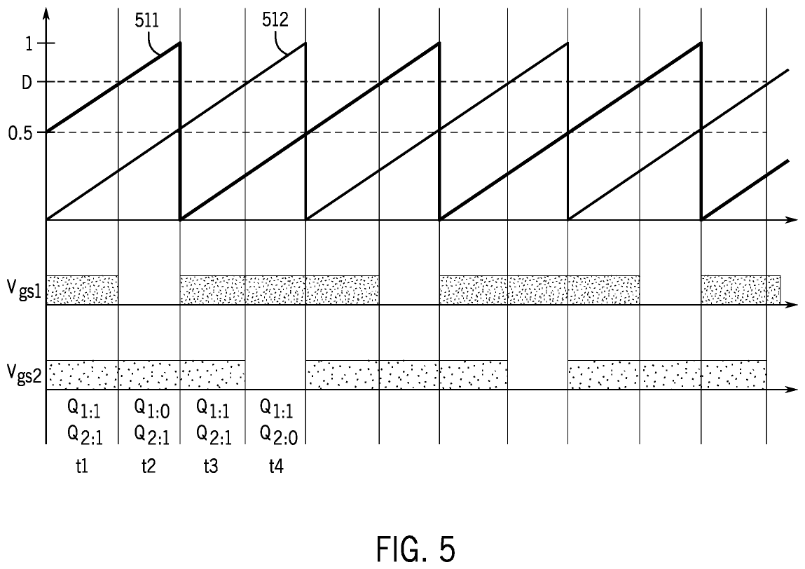

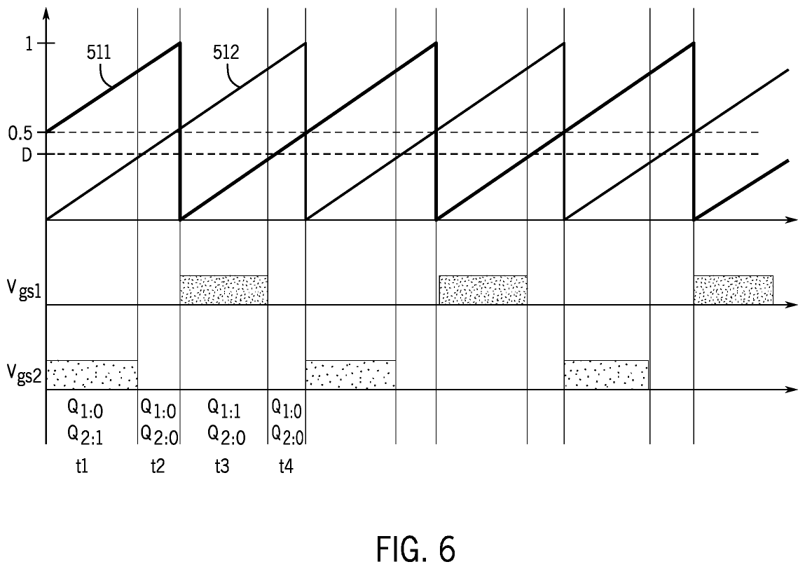

FIGS. 5 and 6 illustrate switching sequences for the series-stacked half bridges of a converter as described above for duty cycles greater than 50% and less than 50%, respectively. As an example, if the converter includes two stages, it will have two series-connected half bridges. Each half bridge can have its own carrier signal (511, 512) with a phase shift of 180° relative to the other. The DC voltage of the bulk capacitors at the output of each half bridge (C1/C2) can be around 200V in the 400V example referred to herein. Because two carriers are used, two switching sequences will take place based of the value of the duty cycle, as shown in FIGS. 5 and 6.

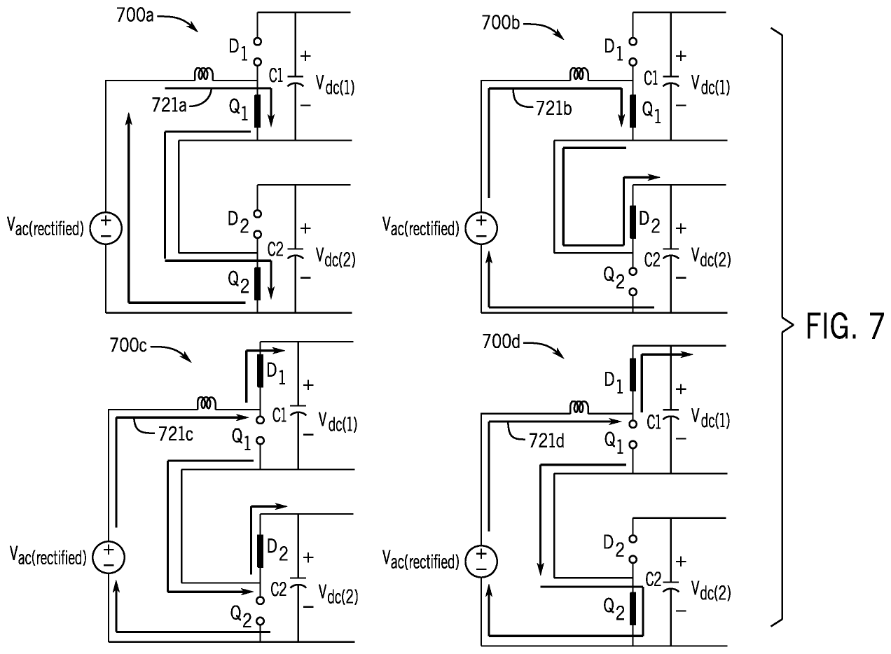

FIG. 5 illustrates the duty cycle greater than 50% case, i.e., D>0.5. The commanded duty cycle (i.e., the current reference signal) can be compared to the respective carrier signals 511, 512 for the first and second half bridges. If the carrier signal for a half bridge is less than the commanded duty cycle, the lower switch of that half bridge can be turned on, as illustrated by the shaded blocks in the Vgs1/Vgs2 plots, which are the gate drive signals to the respective lower switching devices. If the carrier signal for a half bridge is greater than the commanded duty cycle, the lower switch of that half bridge can be turned off, as illustrated by the shaded blocks in the Vgs1/Vgs2 plots, which are the gate drive signals to the respective lower switching devices. Thus, as illustrated in FIG. 5, in a first interval t1, both lower switches are turned on. In a second interval t2, the first lower switch is turned off, while the second lower switch is turned on. In a third interval t3, both lower switches are turned on. In a fourth interval t4, both lower switches are turned off. The current flow and inductor charging/discharging associated with the respective switching states are described in greater detail below with respect to FIG. 7.

FIG. 6 illustrates the duty cycle less than 50% case, i.e., D<0.5. The commanded duty cycle (i.e., the current reference signal) can be compared to the respective carrier signals 511, 512 for the first and second half bridges. If the carrier signal for a half bridge is less than the commanded duty cycle, the lower switch of that half bridge can be turned on, as illustrated by the shaded blocks in the Vgs1/Vgs2 plots, which are the gate drive signals to the respective lower switching devices. If the carrier signal for a half bridge is greater than the commanded duty cycle, the lower switch of that half bridge can be turned off, as illustrated by the shaded blocks in the Vgs1/Vgs2 plots, which are the gate drive signals to the respective lower switching devices. Thus, as illustrated in FIG. 6, in a first interval t1, the lower switch of the second half bridge can be turned on. In a second interval t2, both lower switches can be turned off. In a third interval t3, the lower switch of the first half bridge can be turned on. In a fourth interval t4, both lower switches are turned off. The current flow and inductor charging/discharging associated with the respective switching states are described in greater detail below with respect to FIG. 7.

FIG. 7 illustrates conduction paths during the respective switching states of the series-stacked half bridges. For the exemplary two-stage converter, four switching states 700a, 700b, 700c, and 700d can take place. The conduction paths for each switching state are shown in FIG. 7. Switching state 700a is the switching state in which low side switches Q1, Q2 of both stacked half bridges Q1/D1, Q2/D2 are turned on. The resulting current 721a charges (i.e., stores energy in) inductor L (e.g., PFC choke L, described above). In switching state 700a, the respective DC-DC converters (not shown in FIG. 7) are powered by energy stored in the respective bulk capacitors C1, C2, as the current path from the input rectifier does not pass through the DC-DC converters.

Switching state 700b is the switching state in which low side switch Q1 of first half bridge D1/Q1 is turned on while low side switch Q2 of second half bridge D2/Q2 is turned off. The resulting current 721b charges (i.e., stores energy in) inductor L (e.g., PFC choke L, described above) when the rectified input voltage Vac (rectified) is greater than DC bus voltage Vdc(2) and discharges (i.e., takes energy from) inductor L when the rectified input voltage is less than DC bus voltage Vdc(2). In switching state 700b, the first DC-DC converter is powered by energy stored in the respective bulk capacitor C1, and the second DC-DC converter can be powered directly by the input current 721b.

Switching state 700c is the switching state in which low side switches Q1, Q2 of both stacked half bridges Q1/D1, Q2/D2 are turned off. The resulting current path 721c charges (i.e., stores energy in) inductor L (e.g., PFC choke L, described above) when the rectified input voltage Vac (rectified) is greater than the sum of DC bus voltages Vdc(1) and Vdc(2) and discharges (i.e., takes energy from) inductor L when the rectified input voltage is less than the sum of DC bus voltages Vdc(1) and Vdc(2) and. In switching state 700c, the respective DC-DC converters are powered by directly by the input current 721c.

Switching state 700d is the switching state in which low side switch Q1 of first half bridge D1/Q1 is turned off while low side switch Q2 of second half bridge D2/Q2 is turned on. The resulting current 721d charges (i.e., stores energy in) inductor L (e.g., PFC choke L, described above) when the rectified input voltage Vac (rectified) is greater than DC bus voltage Vdc(1) and discharges (i.e., takes energy from) inductor L when the rectified input voltage is less than DC bus voltage Vdc(1). In switching state 700d, the second DC-DC converter is powered by energy stored in the respective bulk capacitor C2, and the second DC-DC converter can be powered directly by the input current 721d.

As can be understood from the described operation of FIGS. 5-7, increased current demand signals (e.g., a call for increased duty cycle) of the respective half bridges will result in increased current drawn from the rectified input voltage source to ultimately provide greater PSU output power.

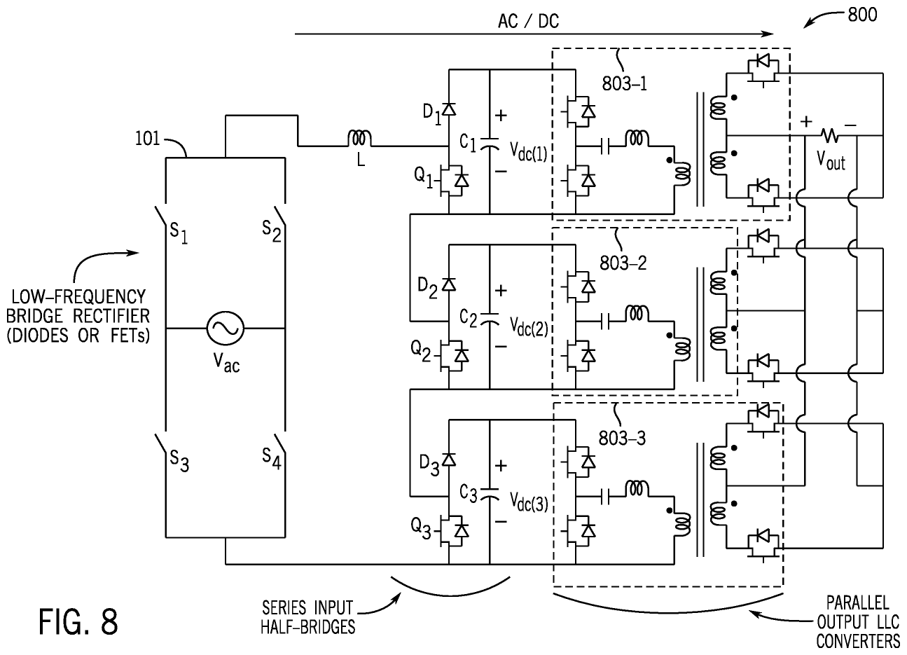

FIG. 8 illustrates a unidirectional power supply unit (PSU) 800 including an isolated AC-DC power supply incorporating a front-end active rectifier using single inductor and series stacked half bridges. The illustrated PSU is a three-stage converter, incorporating three series-stacked half bridges D1/Q1, D2/Q2, D3/Q3 as described above. However, other numbers of stages could be provided. As described above, each half-bridge can be structured by a transistor (e.g., MOSFET) and a diode, or, alternatively, a synchronous rectifier can replace the diode to reduce the conduction losses. The isolated dc/dc converters 803-1, 803-2, and 803-3 can each be an LLC converter. The PWM drive signals for each LLC converter can be phase-shifted the same way as the half-bridges (as described above) to allow for the size of the output capacitor to be reduced.

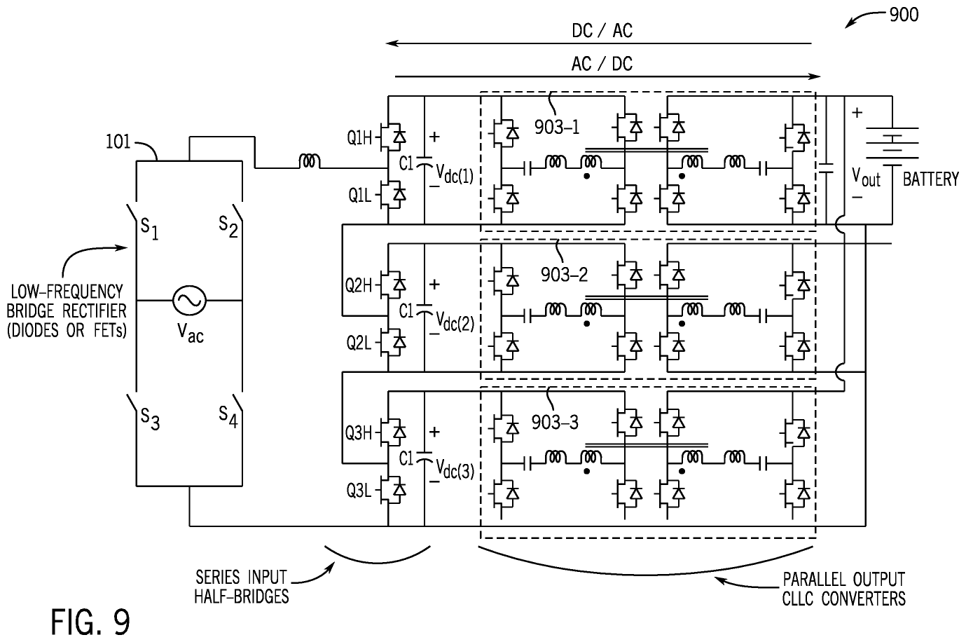

FIG. 9 illustrates a bidirectional power supply unit (PSU) 900 including an isolated AC-DC power supply incorporating a front-end active rectifier using single inductor and series stacked half bridges, which can be used for bidirectional applications (e.g., battery chargers). As with the unidirectional converter 800 of FIG. 8, the bidirectional PSU 900 is illustrated as having three stages, although other numbers of stages could also be implemented. Each half-bridge can be implemented using a pair of MOSFETs Q1H/Q1L, Q2H/Q2L, Q3H/Q3L (or other controllable switching devices) to allow bidirectional power flow. The isolated dc/dc converters 903-1, 903-2, 903-3 can be a CLLC converter or a dual-active-bridge converter. The PWM drive signals for each LLC converter can be phase-shifted the same way as the half-bridges (as described above) to allow for the size of the output capacitor to be reduced.

The foregoing describes exemplary embodiments of isolated AC-DC power supplies incorporating a front-end active rectifier using single inductor and series stacked half bridges. Such configurations may be used in a variety of applications including unidirectional and bidirectional power supplies for varying load levels. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. An AC/DC power supply comprising:
a rectifier that receives an AC input voltage and produces a rectified output voltage;
a plurality of series-stacked half bridges, each of the plurality of series-stacked half bridges comprises an upper switching device and a lower switching device, the plurality of series-stacked half bridges including:
a first series-stacked half bridge having a switch node coupled to the rectifier by a single inductor and operable to produce a first floating DC bus across high side and low side nodes; and
one or more additional series-stacked half bridges each having a switch node coupled to a low side node of a preceding series-stacked half bridge and operable to produce a floating DC bus across high side and low side nodes; and
a plurality of isolated DC-DC converters each having an input coupled to a respective high side node and low side node of a corresponding series-stacked half bridge and all having their outputs connected in parallel to provide a DC output voltage for the AC/DC power supply.

2. The AC/DC power supply of claim 1 wherein the upper switching device is a diode, and the lower switching device is a transistor.

3. The AC/DC power supply of claim 1 further comprising a plurality of bulk capacitors coupled across the high side and low side nodes of respective series-stacked half bridges.

4. The AC/DC power supply of claim 1 further comprising control circuitry for the plurality of isolated DC-DC converters that ensures equal power sharing between the plurality of isolated DC-DC converters.

5. The AC/DC power supply of claim 4 wherein the control circuitry that ensures equal power sharing between the plurality of isolated DC-DC converters compares a target floating DC bus voltage to a voltage of each floating DC bus and generates therefrom a small variation of a manipulated variable of a controller of a corresponding DC-DC converter.

6. The AC/DC power supply of claim 5 wherein the manipulated variable is switching frequency of the corresponding DC-DC converter.

7. The AC/DC power supply of claim 5 wherein the manipulated variable is a resonant capacitor voltage of the corresponding DC-DC converter.

8. The AC/DC power supply of claim 1 further comprising control circuitry for the plurality of series-stacked half bridges that compares the rectified output voltage to a sum of voltages on the isolated DC busses and generates therefrom a reference current signal for a current controller of each series-stacked half bridge.

9. The AC/DC power supply of claim 8 wherein the current controller is selected from the group consisting of a peak current controller and an average current controller and operates in a mode selected from a continuous conduction mode, a discontinuous conduction mode, and a critical conduction mode.

10. The AC/DC power supply of claim 8 wherein the control circuitry for each series-stacked half bridge generates phase shifted drive signals for at least the low side switch of each series-stacked half bridge by comparing the reference current signal to a plurality of phase shifted carrier signals, wherein the carrier signals are phase shifted with respect to each other by 360/n degrees, where n is a number of series-stacked half bridges in the plurality.

11. The AC/DC power supply of claim 10 wherein n is 2.

12. The AC/DC power supply of claim 10 where n is 3.

13. The AC/DC power supply of claim 1 wherein the isolated DC-DC converters are LLC converters.

14. The AC/DC power supply of claim 1 wherein the isolated DC-DC converters are CLLC converters.

15. A unidirectional AC/DC power supply comprising:
a rectifier that receives an AC input voltage and produces a rectified output voltage;
a plurality of series-stacked half bridges, wherein each of the plurality of series-stacked half bridges further comprises an upper switching device and a lower switching device, the plurality of series-stacked half bridges including:
a first series-stacked half bridge having a switch node coupled to the rectifier by a single inductor and operable to produce a first floating DC bus across high side and low side nodes; and
one or more additional series-stacked half bridges each having a switch node coupled to a low side node of a preceding series-stacked half bridge and operable to produce a floating DC bus across high side and low side nodes;
a plurality of bulk capacitors coupled across the high side and low side nodes of respective series-stacked half bridges; and
a plurality of LLC converters each having an input coupled to a respective high side node and low side node of a corresponding series-stacked half bridge and all having their outputs connected in parallel to provide a DC output voltage for the AC/DC power supply.

16. The unidirectional AC/DC power supply of claim 15 further comprising control circuitry for the plurality of LLC converters that ensures equal power sharing between the plurality of LLC converters.

17. The unidirectional AC/DC power supply of claim 15 further comprising control circuitry for the plurality of series-stacked half bridges that compares the rectified output voltage to a sum of voltages on the isolated DC busses and generates therefrom a reference current signal for a current controller of each series-stacked half bridge.

18. A bidirectional AC/DC power supply comprising:
a rectifier that receives an AC input voltage and produces a rectified output voltage;
a plurality of series-stacked half bridges, wherein each of the plurality of series-stacked half bridges further comprises an upper switching device and a lower switching device, including:
a first series-stacked half bridge having a switch node coupled to the rectifier by a single inductor and operable to produce a first floating DC bus across high side and low side nodes; and
one or more additional series-stacked half bridges each having a switch node coupled to a low side node of a preceding series-stacked half bridge and operable to produce a floating DC bus across high side and low side nodes;
a plurality of bulk capacitors coupled across the high side and low side nodes of respective series-stacked half bridges; and
a plurality of CLLC converters each having an input coupled to a respective high side node and low side node of a corresponding series-stacked half bridge and all having their outputs connected in parallel to provide a DC output voltage for the bidirectional AC/DC power supply.

19. The bidirectional AC/DC power supply of claim 18 further comprising control circuitry for the plurality of CLLC converters that ensures equal power sharing between the plurality of CLLC converters.

20. The bidirectional AC/DC power supply of claim 18 further comprising control circuitry for the plurality of series-stacked half bridges that compares the rectified output voltage to a sum of voltages on the isolated DC busses and generates therefrom a reference current signal for a current controller of each series-stacked half bridge.
